(19) United States
(12) Patent Application Publication
(10) Pub. No.: US 2024/0117819 A1
(43) Pub. Date: Apr. 11, 2024

(54) FAN LAMP

(71) Applicants: SUZHOU OPPLE LIGHTING CO., LTD., Suzhou City (CN); OPPLE LIGHTING CO., LTD., Shanghai (CN)

(72) Inventors: Dingde ZHOU, Suzhou City\ (CN); Guobao ZHANG, Suzhou City\ (CN); Zhanhua CHEN, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 18/542,597

(22) Filed: Dec. 16, 2023

Related U.S. Application Data
(63) Continuation of application No. PCT/CN2022/098416, filed on Jun. 13, 2022.

(30) Foreign Application Priority Data
Jun. 25, 2021 (CN) 202121421654.3

(51) Int. Cl. F04D 29/64; F04D 25/06; F04D 25/08; F21V 33/00

(52) U.S. Cl. CPC F04D 29/644; F04D 25/06; F04D 25/088; F21V 33/0096

(57) ABSTRACT

The present disclosure provides a fan lamp, which includes: a mounting base, a suspension rod, a fan assembly, and a lamp assembly, the mounting base is fixedly installed on an installation foundation, the suspension rod is connected with the fan assembly, the fan assembly includes a motor with a fixed shaft, the suspension rod is fixedly connected with the fixed shaft of the motor through at least one connecting piece, and the suspension rod is connected with an end portion of the fixed shaft in a sleeved manner, one of the suspension rod and the fixed shaft that is arranged inside includes at least one first through-hole that penetrates a main body, and the other one of the suspension rod and the fixed shaft that is arranged outside includes at least one pair of a second through-hole and a threaded hole that are arranged on a straight line.

### CROSS-REFERENCE TO THE RELATED APPLICATION

This application is based upon and claims the priority of PCT patent application No. PCT/CN2022/098416 filed on Jun. 13, 2022 which claims priority to the Chinese patent application No. 202121421654.3 filed on Jun. 25, 2021, the entire contents of which are hereby incorporated by reference herein for all purposes.

### TECHNICAL FIELD

The present disclosure relates to a technical field of fan lamp, especially relates to a fan lamp with an improved structure.

### BACKGROUND

A fan lamp has both functions as a fan and a lighting fixture, and is highly popular among consumers. The fan lamp is generally installed on a ceiling, and fan assembly is connected with the ceiling through a suspension rod, because of inevitable vibration generated by a fan motor during operation, a reliability requirement for a motor installation is high.

### SUMMARY

The present disclosure provides a fan lamp.

According to the present disclosure, a fan lamp may include: a mounting base, a suspension rod, a fan assembly, and a lamp assembly, wherein the mounting base may be fixedly installed on an installation foundation, the suspension rod may be connected with the fan assembly, the fan assembly may include a motor with a fixed shaft, the suspension rod may be fixedly connected with the fixed shaft of the motor through at least one connecting piece.

One end of the suspension rod may be connected with the mounting base, and the other end of the suspension rod may be connected with an end portion of the fixed shaft in a sleeved manner, one of the suspension rod and the fixed shaft that may be arranged inside may include at least one first through-hole that penetrates a main body.

The other one of the suspension rod and the fixed shaft that may be arranged outside may include at least one pair of a second through-hole and a threaded hole that may be arranged on a straight line, an end portion of the connecting piece may be provided with threads, and the connecting piece may pass through the first through-hole and the second through-hole and may be in threaded connection with the threaded hole.

It is to be understood that both the foregoing general description and the following detailed description are exemplary and explanatory only and are not restrictive of the present disclosure.

### BRIEF DESCRIPTION OF DRAWINGS

FIG. 1 is a schematic structure diagram of a fan lamp in an example of the present disclosure; and

FIG. 2 is a diagram of an assembled structure in the example of FIG. 1.

### DETAILED DESCRIPTION

The following will provide a further detailed explanation of the present disclosure for the fan lamp in conjunction with the accompanying drawings and examples.

The fan lamp may be installed on a ceiling, and the fan assembly may be connected with the ceiling through a suspension rod, because of inevitable vibration generated by a fan motor during operation, a reliability requirement for a motor installation may be high. Sometimes, six screws may be used to secure the suspension rod to a fixed shaft of a motor from different directions. This method has a complex structure, complicated installation, and high cost.

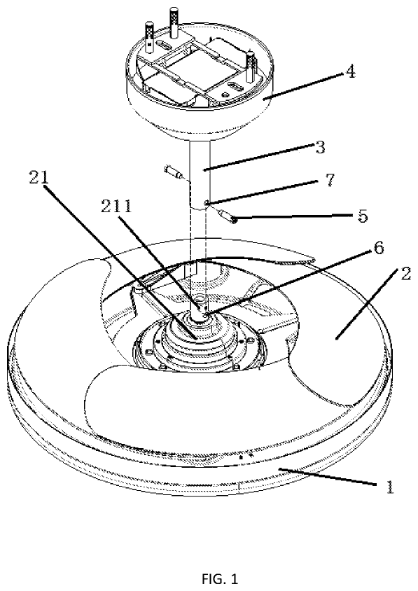

As shown in FIG. 1, the fan lamp includes a mounting base 4, a suspension rod 3, a fan assembly 2, and a lamp assembly 1. The mounting base 4 is fixedly installed on an installation foundation such as a roof, a beam, etc. One end of the suspension rod 3 is connected with the mounting base 4, and the other end of the suspension rod 3 is connected with the fan assembly 2, the lamp assembly 1 is arranged below the fan assembly 2.

In this example, the suspension rod 3 is connected with a fixed shaft 211 of a motor 21 in the fan assembly 2, one end of the suspension rod 3 is connected with the mounting base 4, and the other end is sleeved outside the end portion of the fixed shaft 211. A part of the end portion of the fixed shaft 211 is inserted into the suspension rod 3, and the suspension rod 3 is fixedly connected with the fixed shaft 211 through a connecting piece 5. The number of the connecting pieces 5 is at least one, and can also be multiple, two connecting pieces 5 are included in this example.

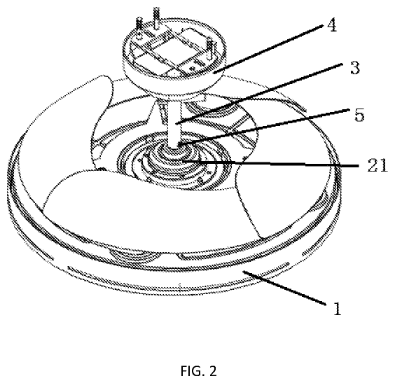

The suspension rod 3 and the fixed shaft 211 are respectively provided with holes for arranging the connecting piece 5, and the connecting piece 5 penetrates the holes to connect the suspension rod 3 and the fixed shaft 211. In this example, the fixed shaft 211 is provided with a first through-hole 6 that penetrates a main body thereof. The suspension rod 3 is cylindrical and is sleeved outside the fixed shaft 211, on opposite side walls of the suspension rod 3, a second through-hole 7 is arranged on one side, and a threaded hole (not shown) is arranged on the other side, and the threaded hole can be a through-hole or a blind hole. The connecting piece 5 is a pin with a threaded segment at the end portion, which is inserted from the second through-hole 7 and passes through the first through-hole 6, the threaded segment matches with the threaded hole. An assembled fan lamp is shown in FIG. 2.

The first through-hole 6, the second through-hole 7, and the threaded hole are all matched with the connecting piece 5, therefore, each connecting piece 5 needs to be equipped with a corresponding first through-hole 6, a second through-hole 7, and a threaded hole, whose numbers are consistent with the number of the connecting piece 5, which are both two in this example. The second through-hole 7 and the threaded hole are always arranged in pairs, in order to ensure optimal balance when the fan rotates, a connecting line of them passes through an axis of the fixed shaft 211. In the case where there are two or more connecting pieces 5, because all of them need to pass through the axis, the connecting pieces 5 needs to be staggered in an axial direction. Therefore, the first through-holes 6 are respectively arranged on different planes perpendicular to the axis of the fixed shaft 211; the pairs of the second through-holes 7 and the threaded holes are respectively arranged on different planes perpendicular to the axis of the fixed axis 211. In this example, because the number of the connecting pieces 5 are two, for a balance purpose, the two connecting pieces 5 are arranged up and down in the axial direction, are opposite to each other and parallel to each other in a plane where the axis of the fixed shaft 211 is located. That is, below or above of a pin head portion of one connecting piece 5 corresponds to a threaded segment of another connecting piece 5. Projections of the two connecting pieces 5 on the plane perpendicular to the axis of the fixed shaft 211 coincide with each other. Of course, in the case where there are more than two connecting pieces, the connecting pieces can be evenly arranged in a circumference direction, at this point, the projections of the connecting pieces 5 on the plane perpendicular to the axis of the fixed shaft 211 intersect with each other.

Installation methods of the suspension rod 3 and the fixed shaft 211 can further be interchanged, the fixed shaft 211 is sleeved outside the suspension rod 3, in this case, the first through-hole 6 needs to be arranged in the suspension rod 3, and the second through-hole 7 and the threaded hole need to be arranged in the fixed shaft 211.

This example is an invisible fan lamp with retractable blades, in the case of not in use, the blades are hidden above the lamp, and in the case of in use, the blades are unfolded. This example is only an example of this patent, and this disclosure is not limited to this. A suspension rod connection structure proposed in this disclosure is also applicable to a ceiling fan lamp with fixed blades.

A connection structure of a pin and threads makes the connection more reliable, reduces the number of connecting pieces, saves material cost, simplifies an assembling process, makes the installation more convenient, and saves installation time.

A purpose of the present disclosure is to solve problems of complex connection structure and complicated installation of the suspension rod of the existing fan lamp, and to provide a fan lamp with an improved structure.

The adopted technical scheme is to provide a fan lamp, which includes: a mounting base, a suspension rod, a fan assembly, and a lamp assembly, the mounting base being fixedly installed on an installation foundation, the suspension rod being connected with the fan assembly, the fan assembly includes a motor with a fixed shaft, the suspension rod is fixedly connected with the fixed shaft of the motor through at least one connecting piece, one end of the suspension rod is connected with the mounting base, and the other end of the suspension rod is connected with an end portion of the fixed shaft in a sleeved manner, one of the suspension rod and the fixed shaft that is arranged inside includes at least one first through-hole that penetrates a main body thereof, and the other one of the suspension rod and the fixed shaft that is arranged outside includes at least one pair of a second through-hole and a threaded hole that are arranged on a straight line, an end portion of the connecting piece is provided with threads, and the connecting piece passes through the first through-hole and the second through-hole and is in threaded connection with the threaded hole.

Preferably, the suspension rod is sleeved outside the fixed shaft, the first through-hole is arranged in the fixed shaft, and the second through-hole and the threaded hole are arranged at opposite sidewall surfaces of the suspension rod, respectively.

Preferably, the fixed shaft is sleeved outside the suspension rod, the first through-hole is arranged in the suspension rod, and the second through-hole and the threaded hole are arranged at opposite sidewall surfaces of the fixed shaft, respectively.

Preferably, a number of connecting pieces is two or more, and a number of first through-holes, a number of second through-holes, and a number of threaded holes are consistent with the number of the connecting pieces.

Preferably, the second through-hole and the threaded hole are arranged in pairs, and a connecting line of the second through-hole and the threaded hole passes through an axis of the fixed shaft.

Preferably, the first through-holes are arranged on different planes perpendicular to the axis of the fixed shaft, respectively; the pairs of the second through-holes and the threaded holes are arranged on different planes perpendicular to the axis of the fixed shaft, respectively.

Preferably, projections of the connecting pieces coincide with each other on a plane perpendicular to the axis of the fixed shaft.

Preferably, projections of the connecting pieces intersect with each other on a plane perpendicular to the axis of the fixed shaft.

Preferably, the number of the connecting pieces is two, and the two connecting pieces are arranged in parallel and up and down in an extension direction of the axis of the fixed shaft in a plane where the axis of the fixed shaft is located, and insertion directions of the two connecting pieces are opposite.

Preferably, the connecting piece is a pin with a threaded segment at the end portion.

In the fan lamp provided by the present disclosure, a connection structure of a pin and threads makes the connection more reliable, reduces the number of connecting pieces, saves material cost, simplifies an assembling process, makes the installation more convenient, and saves installation time.

The above description of examples of the present disclosure is for a purpose of illustration and description, and is not intended to exhaust or limit the present disclosure to specific forms disclosed, obviously, many modifications and changes may be made, which may be apparent to those skilled in the art and should be included within the scope of the present disclosure.

1. A fan lamp, comprising: a mounting base, a suspension rod, a fan assembly, and a lamp assembly, wherein:
the mounting base is configured to be fixedly installed on an installation foundation, the suspension rod is connected with the fan assembly, and
the fan assembly comprises a motor with a fixed shaft, the suspension rod is fixedly connected with the fixed shaft of the motor through at least one connecting piece, one end of the suspension rod is connected with the mounting base, and the other end of the suspension rod is connected with an end portion of the fixed shaft in a sleeved manner, one of the suspension rod and the fixed shaft that is arranged inside comprises at least one first through-hole that penetrates a main body thereof, and
the other one of the suspension rod and the fixed shaft that is arranged outside comprises at least one pair of a second through-hole and a threaded hole that are arranged on a straight line, an end portion of the connecting piece is provided with threads, and the connecting piece passes through the first through-hole and the second through-hole and is in threaded connection with the threaded hole.

2. The fan lamp according to claim 1, wherein the suspension rod is sleeved outside the fixed shaft, the first through-hole is arranged in the fixed shaft, and the second through-hole and the threaded hole are arranged at opposite sidewall surfaces of the suspension rod.

3. The fan lamp according to claim 1, wherein the fixed shaft is sleeved outside the suspension rod, the first through-hole is arranged in the suspension rod, and the second through-hole and the threaded hole are arranged at opposite sidewall surfaces of the fixed shaft.

4. The fan lamp according to claim 1, wherein a number of connecting pieces is two or more, and a number of first through-holes, a number of second through-holes, and a number of threaded holes are consistent with the number of the connecting pieces.

5. The fan lamp according to claim 4, wherein the second through-hole and the threaded hole are arranged in pairs, and a connecting line of the second through-hole and the threaded hole passes through an axis of the fixed shaft.

6. The fan lamp according to claim 5, wherein the first through-holes are arranged on different planes perpendicular to the axis of the fixed shaft, respectively; the pairs of the second through-holes and the threaded holes are arranged on different planes perpendicular to the axis of the fixed shaft.

7. The fan lamp according to claim 6, wherein projections of the connecting pieces coincide with each other on a plane perpendicular to the axis of the fixed shaft.

8. The fan lamp according to claim 6, wherein projections of the connecting pieces intersect with each other on a plane perpendicular to the axis of the fixed shaft.

9. The fan lamp according to claim 7, wherein the number of the connecting pieces is two, and the two connecting pieces are arranged in parallel and up and down in an extension direction of the axis of the fixed shaft in a plane where the axis of the fixed shaft is located, and insertion directions of the two connecting pieces are opposite.

10. The fan lamp according to claim 1, wherein the connecting piece is a pin with a threaded segment at the end portion.
